(19) United States
(12) Patent Application Publication
(10) Pub. No.: US 2026/0001213 A1
(43) Pub. Date: Jan. 1, 2026

(54) POWER HAND TOOL MOUNTING

(71) Applicant: Joseph E. Boyanich, Medina, NY (US)

(72) Inventor: Joseph E. Boyanich, Medina, NY (US)

(21) Appl. No.: 18/755,775

(22) Filed: Jun. 27, 2024

(51) Int. Cl. B25H 1/00

(52) U.S. Cl. CPC B25H 1/0021

(57) ABSTRACT

A support accessory is configured to be detachably fastened to a power hand tool having a motor housing with first and second threaded apertures. The support accessory has a U-shaped support housing, a clamp-locking protrusion, a first securing apparatus, and a second securing apparatus. The first and second securing apparatuses each has a head threaded bushing, a bushing gasket that secures the head threaded bushing in place, a bushing nut that further secures the head threaded bushing in place, and a bolt. Each head threaded bushing has a central aperture that extends from the bushing distal end to the first bushing proximal end. Some of the bushing's proximal end contacts the U-shaped support housing that surrounds an aperture positioned on each side of the U-shaped support housing. Each bolt enters a respective central aperture and secures to a respective threaded aperture.

### FIELD OF THE DISCLOSURE

The present application relates generally to an accessory for a power hand tool that vibrates when the power hand tool operates.

### BACKGROUND OF THE INVENTION

Power hand tools, such as and not limited to an oscillating tool, a grinder, a polisher, a sander, a metal cutter, a circular saw, a jigsaw, a drill, a hammer-drill, and a router are used in a wide variety of manufacturing environments, including in the medical device, woodworking, and automotive industries. Certain hand tools can be quite heavy and cumbersome. Even so, in some cases, a tool operator or craftsperson may be required to hold and maneuver the power hand tool in a particular position or orientation with respect to a workpiece for an extended period of time, such as an 8-hour work shift. In such cases, the tool operator may experience fatigue, strain, or even injury over time from holding the power hand tool.

In addition, in some cases, an operator may simply be incapable of (a) supporting the weight of the power hand tool and/or (b) handling the vibration of the power hand tool for an extended time period. In such cases, the power hand tool, or a portion of it may become misaligned or unbalanced, which may cause damage to the power hand tool and/or the workpiece. To provide an example, a power hand grinder tool may include a head with a rotating brush—for this application, the rotating brush part of the power hand tool would be referred to as the tool of the power hand tool—that is intended to remain parallel to a workpiece's surface. If the tool operator or craftsperson struggles to maintain the desired power hand tool position, the head may tilt over time, making it difficult to grind the workpiece's surface, particularly if the workpiece is contoured. In addition, tilting of the power hand tool's head may cause uneven wear of the rotating brush, which may in turn require more frequent brush replacement, costing time and money.

The above-identified problems have been previously identified in US published patent application number 2015/0072596 wherein The Boeing Company attempted to solve those problems with a support accessory configured to be detachably fastened to a hand tool. Boeing's support accessory appears to have a frame with (a) a longitudinal beam configured to stabilize the hand tool from front-to-back when the power hand tool is fastened to the support accessory, and (b) a trunnion rotatably coupled to the frame and configured to stabilize the hand tool from side-to-side when the hand tool is fastened to the support accessory. The support accessory is configured to support the power hand tool in a position that is substantially parallel to a surface of a workpiece.

That application discloses a unique support apparatus designed for one of Boeing's specific power hand tools. In contrast, the present invention solves those problems for ordinary power hand tools that can be purchased at, for example and not limited, The Home Depot® stores, or Lowe's® stores.

### SUMMARY OF THE INVENTION

The present application discloses a support accessory that advantageously makes it possible for a craftsperson to detachably attach a power hand tool to, for example, a clamp that can be part of a workbench or interconnected to another object. The support accessory also permits the craftsperson to position the power hand tool at a desired location and angle. In addition to offering such degrees of freedom regarding location and angle, the support accessory permits the craftsperson to guide a workpiece over the stationary power hand tool that should have decreased undesired motion when (i) the power hand tool is (a) operating and (b) operating upon a workpiece or (ii) a workpiece is being applied to the operating power hand tool.

The support accessory is configured to be detachably fastened to the power hand tool. The support accessory comprises a frame having a longitudinal beam. The support accessory is configured to stabilize and decrease the power hand tool from having undesirable movements—for example, movements that go (a) from front-to-back and vice versa, and (b) up-to-down and vice versa. Those undesirable movements are decreased occurs when the power hand tool is not attached or fastened to the support accessory. The support accessory also has a trunnion when the support accessory is removably attached to the power hand tool, and that trunnion is positioned along an aperture axis of the power hand tool. The trunnion is formed when a first securing apparatus and a second securing apparatus positioned, respectively, (a) in a first aperture on a first side of a U-shaped support housing of the support accessory and a second aperture on a second side of the U-shaped support housing of the support accessory; and (b) in a first threaded aperture on a first side of the power hand tool and a second threaded aperture on a second side of the power hand tool.

The support accessory is configured to be detachably fastened to a power hand tool having (a) a motor housing with first and second threaded apertures that are on opposite sides of the motor housing, (b) a motor, and (c) a tool. The support accessory has a U-shaped support housing having apertures along the side surfaces of the U-shaped support housing, a clamp-locking protrusion, a first securing apparatus, and a second securing apparatus. The first and second securing apparatuses each has a head threaded bushing, a bushing gasket that secures the head threaded bushing in place, a bushing nut that further secures the head threaded bushing in place, and a bolt. Each head threaded bushing has a central aperture that extends from the bushing distal end to the bushing proximal end. Some of the bushing's proximal end contacts the U-shaped support housing that surrounds the aperture positioned on each side of the U-shaped support housing. Each bolt enters a respective central aperture and secures to a respective threaded aperture. The craftsperson is able to manipulate the position of the power hand tool in the support accessory by re-positioning the first securing apparatus, and the second securing apparatus in the apertures positioned on each side of the U-shaped support housing.

The trunnion, which is along an aperture axis of the threaded apertures, the first securing apparatus, and the second securing apparatus, is adapted to configure the power hand tool's position and simultaneously decrease unnecessary side-to-side and up-to-down movements of the power hand tool when the power hand tool is fastened to the support accessory and operating. The support accessory can support the power hand tool in a position that is substantially parallel to the beam or, in some embodiments be at an acute angle relative to the beam as measured from the trunnion.

### BRIEF DESCRIPTION OF THE DRAWINGS

FIG. 1 illustrates a power hand tool and a support accessory in an exploded format.

FIG. 2 illustrates a power hand tool and a support accessory joined together.

FIG. 3 illustrates FIG. 1 of the support accessary along the lines 3-3.

FIG. 4 illustrates an exploded view of the proximal side of the support accessory of FIG. 1.

FIG. 5 illustrates a side view of FIG. 2 illustrating three pivotable positions of the power hand tool in the support accessory.

FIG. 6 illustrates a bottom, distal side view of FIG. 2.

FIG. 7 illustrates FIG. 6 without the power hand tool.

FIG. 8 illustrates an alternative embodiment of the invention shown in FIG. 4.

FIG. 9 illustrates one version of the tube used in the FIG. 8 embodiment.

FIG. 10 illustrates a tube's compression knob shown in FIG. 9 along lines 10-10.

Like reference numbers and designations in the various drawings indicate like elements.

### DETAILED DESCRIPTION OF THE INVENTION

### Power Hand Tool

To understand and appreciate the current invention, an understanding of a conventional power hand tool 400 is necessary.

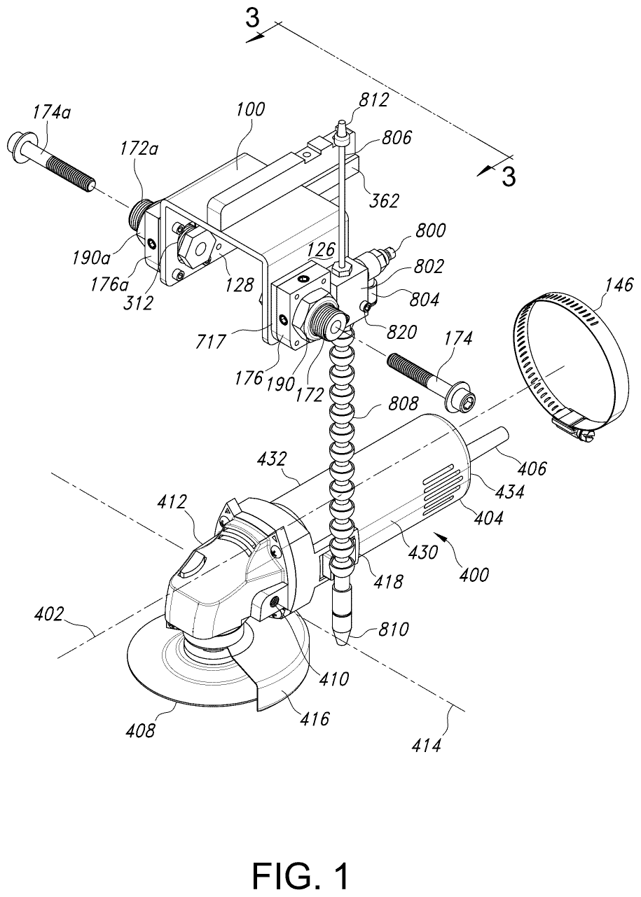

An example of the conventional power hand tool 400 is illustrated at FIG. 1. The power hand tool 400 has a longitudinal axis 402. The conventional power hand tool 400 can be, for example and not limited to, an oscillating tool, a grinder, a polisher, a sander, a metal cutter, a circular saw, a jigsaw, a drill, a hammer-drill, and a router. Those power hand tools are made by other manufacturers. Those manufacturers can be, for example and not limited to, Milwaukee, DeWalt, Ryobi, Avid Power, Hilti, and Makita. The power hand tool 400 has, generically, a motor housing 404 that contains a motor (not shown). The motor, when interconnected to a power source 406 and turned on, has the ability to provide sufficient power to a tool 408 to accomplish the desired power hand tool's objective. The power source 406 could be a battery pack, fuel, pneumatic, or a power cord. The power cord embodiment is adapted to be connected to an electrical outlet, the battery pack embodiment is designed to be re-chargeable, and fuel is if the motor has as a combustible engine. That motor is responsible for the power and movement of the tool 408 of the power hand tool 400. The motor, the power source, and the tool are (a) conventional products, (b) known to those of ordinary skill in the art, and (c) are not a part of the claimed invention.

Many, not all, conventional power hand tools 400 also have a proximal threaded aperture 410 and a distal threaded aperture 412. The proximal threaded aperture 410 and the distal threaded aperture 412 are each adapted to receive an idle handle or a side handle. An idle handle or a side handle is often sold (a) with or (b) as an accessory for the power hand tool 400 by the respective manufacturer. The idle handle or the side handle is adapted to (i) connect to either the distal threaded aperture 412 or the proximal threaded aperture 410, and (ii) protrude perpendicular or almost perpendicular from the motor housing 404 in order to permit a craftsperson to hold and position the power hand tool 400 more conveniently in place. An object of this application is to decrease the need for the idle handle or the side handle.

In most instances, the distal threaded aperture 412 and the proximal threaded aperture 410 are positioned along an aperture axis 414. The aperture axis 414 is perpendicular or about perpendicular to the power hand tool's longitudinal axis 402, with the understanding that the aperture axis 414 and the longitudinal axis 404 need not be in the same plane.

The distal threaded aperture 412 is positioned on the motor housing's distal side 432 while the proximal threaded aperture 410 is positioned on the motor housing's proximal side 430. In addition, the distal threaded aperture 412 and the proximal threaded aperture 410 are positioned over (a) a portion of the tool 408, or (b) between the tool 408 and power hand tool's rear side 434.

When the power hand tool 400 is an oscillating tool, a grinder, a polisher, a sander, a metal cutter, a circular saw, a jigsaw, a drill, a hammer-drill, and/or a router, the power hand tool 400 normally has a safety guard 416 positioned over a portion of the tool 408 in order to decrease chances that the craftsperson will get injured from (a) the tool 408, (b) a loose piece from the workpiece that the tool 408 is working thereon, or (c) equivalents thereof.

The power hand tool 400 also normally has an on/off trigger switch 418 that permits a user to turn the power hand tool 400 on or off when desired, and a power trigger or switch (not shown) that permits the craftsperson to control the speed and/or power of the tool 408 that is being or could be applied to the workpiece.

The above-identified structures of the power hand tool 400 are, in relation to this application, in the public domain since those components have not been conceived or reduced to practice by the Applicant.

### Support Accessory

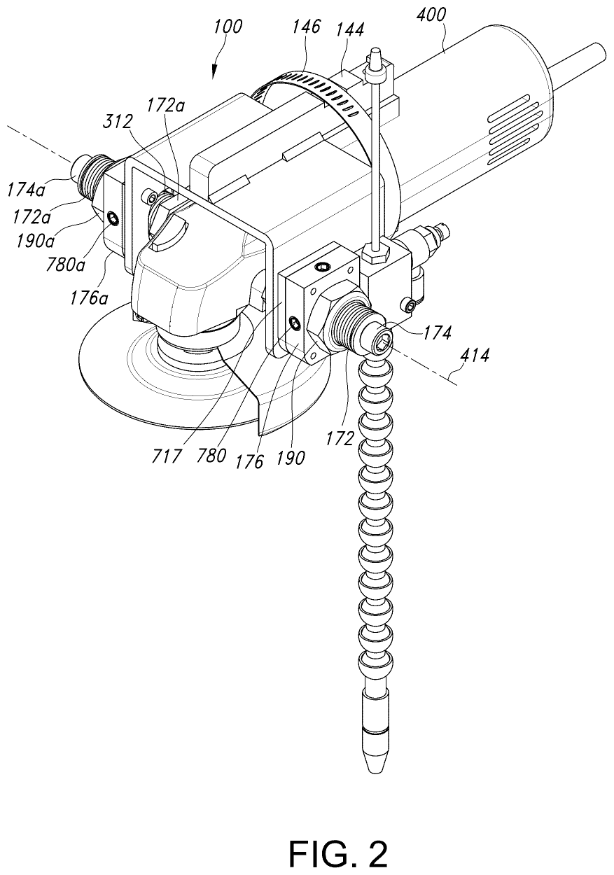

Instead, the Applicant did conceive and reduce to practice a support accessory 100, as illustrated in FIG. 1, configured to be detachably fastened to the power hand tool 400, as shown in FIG. 2. As expressed above, the power hand tool 400 that can be used with the support accessory 100 should have the distal threaded aperture 412 and the proximal threaded aperture 410 as illustrated in FIG. 1.

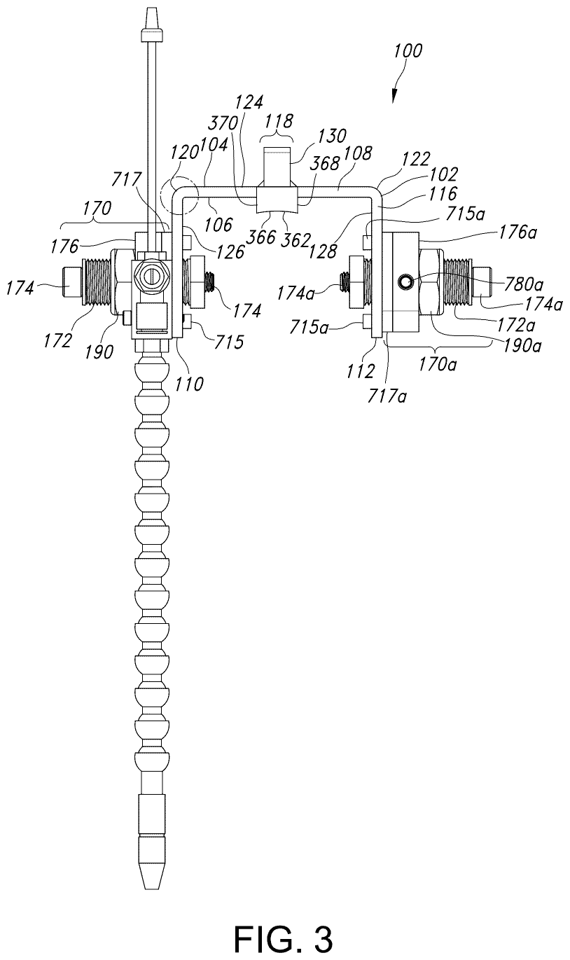

The support accessory 100 has, as illustrated at FIG. 3, a U-shaped support housing 102, a clamp-locking protrusion or longitudinal beam 130, a first securing apparatus 170 and a second securing apparatus 170a. The support accessory 100 can be made from metal, plastic, glass, or combinations thereof on the condition that the support accessory 100 can (a) detachably fasten to a power hand tool and (b) be detachably fasten to a clamp or clamp-like device. It should be acknowledged that the first securing apparatus 170 and the second securing apparatus 170a have the same parts with the understanding that each part on each side can be identical in size or different in size depending on how the hand power tool 400 is to be utilized.

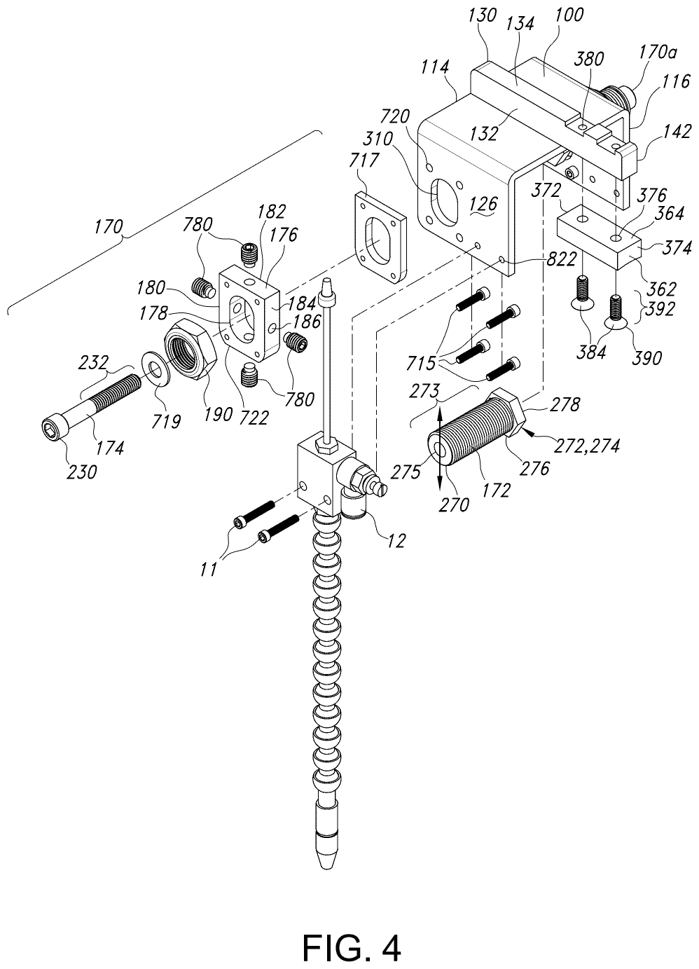

The U-shaped support housing 102 has, as illustrated at FIG. 3, an exterior surface 104, an interior surface 106, and a side surface 108. The side surface 108 separates the exterior surface 104 from the interior surface 106. The side surface 106 is normally 0.1 to 20 cm and can be any dimension so long as the craftsperson is able to move, manually or with equipment, the support apparatus. The U-shaped support housing 102 also has a proximal end 110, a distal end 112, a front end 114 (see, FIG. 4), a rear end 116, and a middle area 118 in a spacing area 124. The middle area 118(a) is at or near the mid-point between the proximal end 110 and the distal end 112, and (b) extends from the front end 114 to the rear end 116.

To have the “U-shape”, the housing 102 has, as illustrated at FIG. 3, a proximal bend area 120, a distal bend area 122, the spacing area 124, a proximal downward area 126, and a distal downward area 128. The proximal bend area 120 is between the spacing area 120 (and middle area 118) and the proximal downward area 126 (and the proximal end 110) and extends from the front end 114 to the rear end 116. Similarly, the distal bend area 122 is between the spacing area 120 (and middle area 118) and the distal downward area 128 (and the distal end 112) and extends from the front end 114 to the rear end 116.

The support accessory's distance between the proximal downward area 126, and the distal downward area 128 is greater than the distance between the distal threaded aperture 412 and the proximal threaded aperture 410 as measured from the motor housing's distal side 432 to the motor housing's proximal side 430. The support accessory's distance between the proximal end 110 on the proximal downward area 126, and the distal end 112 on the distal downward area 128 is, is about, slightly less, or slightly greater than the distance of the spacing area 120 since the proximal downward area 126, and the distal downward area 128 are at about a right (90-degree or straight) angle in relation to the spacing area 120. The proximal bend area 120 and the distal bend area 122 can be (a) a right, straight angle, (b) an eased, rounded edge, (c) a beveled edge, (d) a half bullnose edge, (e) an ogee edge; or (f) combinations thereof. As a result of the various edges that can be used in the proximal bend area 120 and the distal bend area 122; the proximal downward area 126, and the distal downward area 128 are not always at a right (90-degree or straight) angle in relation to the spacing area 120 yet are close (±10-degrees, preferably ±5-degrees) to 90-degrees in relation to the spacing area 120.

The spacing area 120 is positioned between the proximal bend area 120 and the distal bend area 122; and contains the middle area 118. The proximal downward area 126 includes the proximal end 110 and extends up to the proximal bend area 120 and has at least one proximal aperture 310 (see, FIG. 4). The distal downward area 128 includes the distal end 112 and extends up to the distal bend area 128; and has at least one distal aperture 312 (see, FIG. 1).

The proximal aperture 310 is positioned to align with the proximal threaded aperture 410 of the power hand tool 400 and the distal aperture 312 is positioned to align with the distal threaded aperture 412 of the power hand tool 400 when the support accessory 100 is detachably fastened to the power hand tool 400. That means, there is at least one set of the proximal aperture 310 and the distal aperture 312 that are paired together that are always aligned with each other.

Each aligned set of the proximal aperture 310 on the proximal downward area 126 and the distal aperture 312 on the distal downward area 128 is also identical in shape and can be any shape so long as a first securing apparatus 170 (described below in greater detail) can have one of its components (a) extend through the proximal aperture 310 and (b) contact at least a portion of the proximal downward area 126 that surrounds the proximal aperture 310; and a second securing apparatus 170a (also described below in greater detail) can have one of its components (a) extend through the distal aperture 312 and (b) contact at least a portion of the distal downward area 128 that surrounds the distal aperture 312. Preferably, the proximal aperture 310 and the distal aperture 312 are either a circular shape, or an oblong circular shape as illustrated in FIGS. 1 and 4.

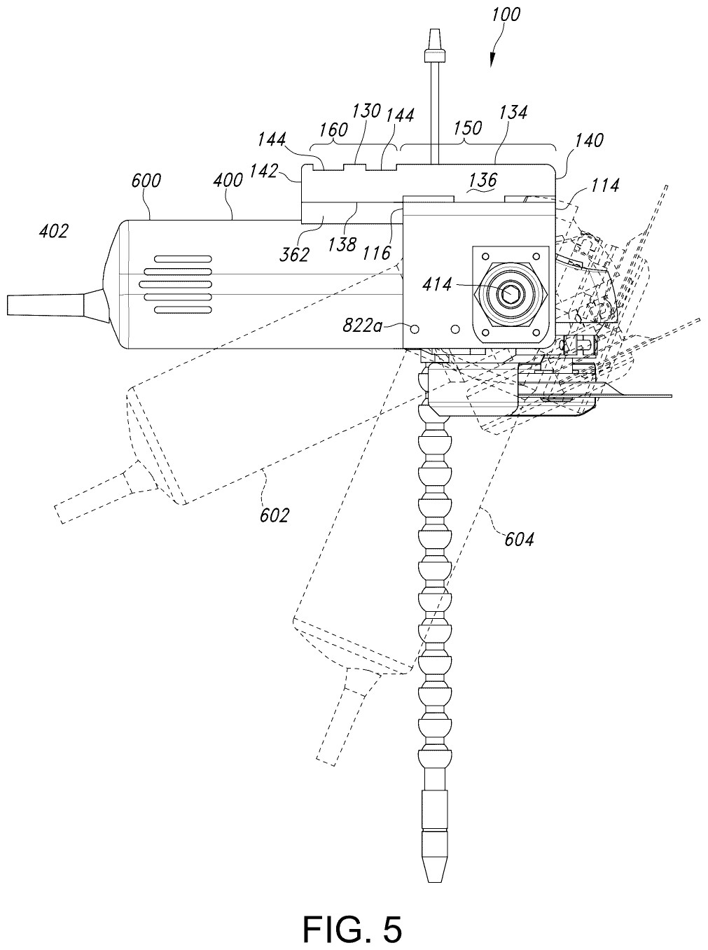

The oblong circular shape and circular shape permits the power hand tool 400 to be positioned at various angles in relation to the clamp-locking protrusion or beam 130. FIG. 5 illustrates three possible positions that rotate about the aperture axis 414. The first position 600 has the power hand tool's 400 longitudinal axis 402 parallel with (or at a 0-degree angle in relation to) the clamp-locking protrusion or longitudinal beam 130. The second position 602 has the power hand tool's 400 longitudinal axis 402 at a 20-degree angle in relation to the clamp-locking protrusion or longitudinal beam 130. The third position 604 has the power hand tool's 400 longitudinal axis 402 at an 80-degree angle in relation to the clamp-locking protrusion or longitudinal beam 130. Obviously, the power hand tool's 400 longitudinal axis 402 can range anywhere from 0-degrees to 89-degrees in relation to the clamp-locking protrusion or longitudinal beam 130 with the circular shape or the oblong circular aperture shapes. It is understood that the oblong circular aperture shape should provide greater degrees of freedom with the power hand tool's position in relation to the clamp-locking protrusion or longitudinal beam 130 because the first and second securing apparatuses 170, 170a can be adjusted to different locations within the oblong circular shape for the proximal aperture 310 and the distal aperture 312.

The oblong circular shape for the proximal aperture 310 and the distal aperture 312 can be at a 90-degree angle in relation to the clamp-locking protrusion or beam 130 as illustrated in FIG. 4, at a 0-degree angle in relation to clamp-locking protrusion of beam 130; or at any angle between 0-degree and 90-degree in relation to clamp-locking protrusion of beam 130. The various angles of the oblong circular shape for the proximal aperture 310 and the distal aperture 312 permits the craftsman to alter the various positions of the power hand tool 400 in relation to the clamp-locking protrusion or beam 130 for different projects. It is also understood that two or more oblong circular shapes may intersect or cross each other to form the proximal aperture 310 having a multi-angle single aperture and the distal aperture 312 having a multi-angle single aperture wherein, for example, (a) a first oblong circular shape for the proximal aperture 310 and the distal aperture 312 is at a first angle, (b) a second oblong circular shape for the proximal aperture 310 and the distal aperture 312 is at a second angle, and (c) the first oblong circular shape and the second oblong circular shape intersect to permit the craftsperson to properly position the power hand tool 400 in relation to the clamp-locking protrusion or beam 130 to provide the desired position for the power hand tool 400.

The circular aperture shape, in relation to the oblong aperture shape, normally limits the movement of the power hand tool 400 in relation to the clamp-locking protrusion or beam 130.

It is also understood that the proximal downward area 126 and the distal downward area 128 can each have two or more distinct apertures, for example and not limited to (since the apertures can be any shape): two distinct oblong circular apertures, two intersecting oblong circular apertures (discussed above), an oblong circular aperture & a circular aperture, or two distinct circular apertures.

The clamp-locking protrusion 130 has a clamp-locking proximal surface 132 (see, FIG. 4), a clamp-locking top surface 134, a clamp-locking distal surface 136 (see, FIG. 5), a clamp-locking bottom surface 138, a clamp-locking front surface 140, and a clamp-locking rear surface 142. In addition to those generic surfaces, the clamp-locking protrusion 130 has a clamp section 150 and a locking section 160. See, FIG. 5.

The clamp section 150 has the clamp-locking front surface 140 and a portion of the clamp-locking proximal surface 132, the clamp-locking top surface 134, the clamp-locking distal surface 136, and the clamp-locking bottom surface 138. The clamp section's clamp-locking bottom surface 135 is securely attached to the exterior surface 104, in particular in the spacing area 124, and preferably at the middle area 118. Securely attached means the clamp-locking bottom surface 135 and the exterior surface 104 can (a) come together by welding, adhesives, nuts & bolts, nuts, rivets, and combinations thereof; or (b) be formed from the U-shaped support housing 102.

The clamp section 150, as illustrated in FIG. 5, extends from the front end 114 to the rear end 116; with the understanding that the clamp section 150 need not extend that entire length from the front end 114 to the rear end 116. That means, the clamp section 150 can extend from the rear end 116 toward the front end 114 while not contacting the front end 114. The clamp section 150 is designed to permit a clamp to removably attach onto the clamp-locking protrusion 130 so the support accessory 100 can be properly and securely positioned in a desired place.

In addition, the clamp-locking proximal surface 132, and the clamp-locking distal surface 136 are normally identical in height (obviously, the heights may be different) and have a sufficient height from the clamp-locking top surface 134 to clamp-locking bottom surface 138 to permit the support accessory 100 to be attached to a conventional clamp (not shown). The sufficient height from the clamp-locking top surface 134 to clamp-locking bottom surface 138 for the clamp-locking proximal surface 132, and the clamp-locking distal surface 136 is dependent upon the clamp being used, but the sufficient height normally ranges from 1 cm to 20 cm.

Likewise, a sufficient width of the clamp-locking top surface 134 that extends from the clamp-locking proximal surface 132, and the clamp-locking distal surface 136 is also dependent upon the clamp being used, with the understanding that the sufficient width normally ranges from 1 cm to 20 cm.

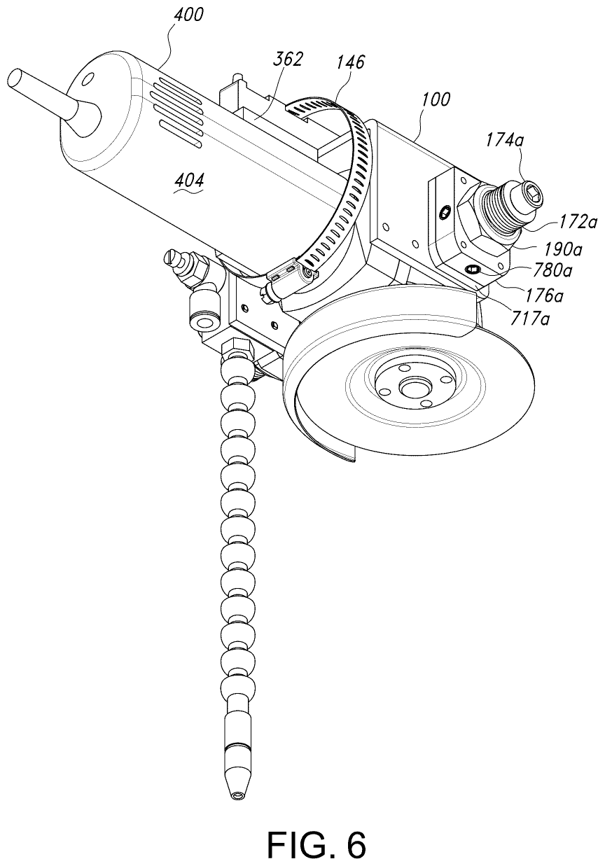

The locking section 160 has the clamp-locking rear surface 142 and a portion of the clamp-locking proximal surface 132, the clamp-locking top surface 134, the clamp-locking distal surface 136, and the clamp-locking bottom surface 138. The locking section 160 extends beyond the housing rear end 116. The locking section 160 can also have at least one locking indentation 144 on the clamp-locking top surface 134. As illustrated at FIG. 5, there can be two locking indentations 144 on the locking section 160, with the understanding that there can be more locking indentations than that which is illustrated or less locking indentations than that which is illustrated. The locking indentations are positioned so a locking band clamp 146 (see, FIGS. 1, 2, and 6) can be adapted to be positioned in the at least one locking indentation 144 and around the motor housing 404 when the power hand tool 400 is detachably fastened to the support accessory 100.

The locking section 160 can also have a saddle 362 (see, FIGS. 3, 4, and 5) attached to at least the locking section's clamp-locking bottom surface 138. The saddle 362 has a saddle top surface 364, a saddle bottom surface 366, a saddle distal side surface 368, a saddle proximal side surface 370, a saddle front end 372, a saddle rear end 374, and, optionally, at least one saddle aperture 376. The saddle distal and proximal side surfaces 368, 370, the saddle rear end 374, and the saddle front end 372 separate the saddle top surface 364 from the saddle bottom surface 366. The at least one saddle aperture 376 extends from the saddle bottom surface 366 to the saddle top surface 364. The saddle top surface 364 contacts at least the clamp-locking bottom surface 138 of the locking section 160. Through nuts, bolts 384 (see, FIG. 4), rivets, adhesive, welds, hooks & loops, and combinations thereof, the saddle 362 attaches to the clamp-locking bottom surface 138 of locking section 160.

In a preferred embodiment, the saddle bottom surface 366 has a concave surface (see, FIG. 3) from the saddle distal side surface 368 to the saddle proximal side surface 370. The concave surface is designed to conform to the motor housing 404 when the power hand tool 400 is detachably fastened to the support accessory 100 and in the first position 600 wherein the power hand tool's 400 longitudinal axis 402 is parallel with (or at a 0-degree angle in relation to) the clamp-locking protrusion or longitudinal beam 130.

In many instances and not all instances, the locking section 160 has at least one threaded locking aperture 380 (see, FIG. 4) that corresponds with the optional at least one saddle aperture 376. The at least one threaded locking aperture 380 extends from the clamp-locking bottom surface 138(a) toward the clamp-locking top surface 134, and in some instances (b) to the clamp-locking top surface 134 or (c) to the clamp-locking top surface 134 in the at least one locking indentation 144 as illustrated at FIG. 4. In this embodiment, the saddle 362 can be properly aligned with the locking section 160 when the at least one saddle aperture 376 and the at least one threaded locking aperture 380 are also aligned. When the at least one saddle aperture 376 and the at least one threaded locking aperture 380 are also aligned, the threaded or saddle bolt 384 can be threaded into the at least one saddle aperture 376 and the at least one threaded locking aperture 380 to securely attach the saddle to the locking section 160. As illustrated at FIG. 4, there are two sets of (a) the threaded bolt 384, (b) the saddle aperture 376 and (c) the threaded locking aperture 380. That said, there can also be a single set as described above, two sets as illustrated, or many more depending on the size of the hand power tool 400 and the corresponding support apparatus 100.

The at least one saddle bolt 384 has a head 390 and a threaded distal end 392. The head 390 is adapted to contact the saddle bottom surface 366 so the saddle bottom surface 366 has a surface that can contact, and preferably not damage, the motor housing 404. While the threaded distal end 392 extends through the at least one saddle aperture 376 to be removably secured to the at least one threaded locking aperture 380.

Turing to FIG. 4, the first securing apparatus 170 has a first head threaded rod with a manufactured nut 172 the manufactured nut can contact the interior surface of the distal downward area 128, a first bushing gasket 176, at least one first gasket fastener 715, a first bushing nut 190, a first bolt 174, and at least one first set locking set screw 780. Optionally, there can also be a first gasket washer 717, and a first nut washer 719.

The first head threaded bushing 172 has (i) a first bushing distal end 270, (ii) a first bushing proximal end 272, (iii) a first bushing threaded area 273 positioned between the first bushing distal end 270 and the first bushing proximal end 272, and (iv) a first central aperture 275 that extends from the first bushing distal end 270 to the first bushing proximal end 272. The first bushing proximal end 272 has a first head portion 274. The first head portion 274 has (a) a first head distal end 276 adapted to contact at least some of the interior surface 104 surrounding the at least one proximal aperture 310 when the first bushing distal end 270 and the first bushing threaded area 273 are inserted into and through at least one proximal aperture 310, and (b) a first head proximal end 278 adapted to face the motor housing 404, when the power hand tool 400 is positioned and adapted to be removably attached to the support accessory 100.

The first bushing gasket 176 has a first gasket aperture 178 that corresponds in shape and size of the proximal aperture 310, a first front gasket surface 180, a first rear gasket surface 182, and a first side gasket surface 184. The first rear gasket surface 182 faces the exterior surface of proximal downward area 126. The first bushing gasket 176 is securely positioned over the exterior surface of proximal downward area 126 by the at least one first gasket fastener 715 so the first gasket aperture 178 and the proximal aperture 310 are aligned.

Optionally, the gasket washer 717 is positioned between the first bushing gasket 176 and the exterior surface 104 of the proximal downward area 126.

The first side gasket surface 184(i) separates the front gasket surface 180 from the rear gasket surface 182, and (ii) has at least one first set screw aperture 186 that extends from the first side gasket surface 182 to the first gasket aperture 178.

The at least one first gasket fastener 715 which can be a screw, a bolt or equivalent thereof, passes through at least one fastener aperture 720 positioned around the proximal aperture 310 on the proximal downward area 126, and a corresponding gasket-fastener aperture 722. Preferably the corresponding gasket-fastener aperture 722 is threaded to secure the first bushing gasket 176, and optionally, the gasket washer 717, to the proximal downward area 126.

The first bushing nut 190 securely attaches to the first bushing threaded area 273 that projects beyond the first front gasket surface 180 as illustrated in FIGS. 3 and 4.

The first bolt 174 has a first head 230, a first threaded end 232, and a length greater than the first head threaded bushing 172 as illustrated at FIG. 3. The first threaded end 232 is adapted to be inserted into the first central aperture 275 in order to threadably connect with the proximal (or first) threaded aperture 410 when the support accessory 100 is positioned and adapted to be detachably fastened to the power hand tool 400. Optionally, the nut washer 719 can be positioned between the first head 230 and the first bushing distal end 270.

The at least one first set screw 780 is adapted to (a) being screwed in the at least one first set screw aperture 186, (b) contact the first bushing threaded area 273 or the same area if the first bushing is not threaded, and (c) secure the position of the first securing apparatus 170 in a desired location in the proximal aperture 310.

The second securing apparatus 170a is very similar to the first securing apparatus 170; in that it has a second head threaded bushing 172a, a second bushing gasket 176a, at least one second gasket fastener 715a, a second bushing nut 190a, a second bolt 174a, and at least one second set screw 780a. Optionally, there can also be a second gasket washer 717a, and a second nut washer 719a.

The second head threaded bushing 172a has (i) a second bushing distal end 270a, (ii) a second bushing proximal end 272a, (iii) a second bushing threaded area 273a positioned between the second bushing distal end 270a and the second bushing proximal end 272a, and (iv) a second central aperture 275a that extends from the second bushing distal end 270a to the second bushing proximal end 272a. The second bushing proximal end 272a has a second head portion 274a. The second head portion 274a has (a) a first second distal end 276a adapted to contact at least some of the interior surface 104 surrounding the at least one distal aperture 312 when the second bushing distal end 270a and the second bushing threaded area 273a are inserted into and through at least one distal aperture 312, and (b) a second head proximal end 278a adapted to face the motor housing 404, when the power hand tool 400 is positioned and adapted to be removably attached to the support accessory 100. In some embodiments, each head threaded bushing is a hex head threaded bushing.

The second bushing gasket 176a has a second gasket aperture 178a that corresponds in shape and size of the distal aperture 312, a second front gasket surface 180a, a second rear gasket surface 182a, and a second side gasket surface 184a. The second rear gasket surface 182a faces the exterior surface of distal downward area 128. The second bushing gasket 176a is securely positioned over the exterior surface of distal downward area 128 by the at least one first gasket fastener 715 so the second gasket aperture 178a and the distal aperture 312 are aligned.

Optionally, the second gasket washer 717a is positioned between the second bushing gasket 176a and the exterior surface 104 of the distal downward area 128.

The second side gasket surface 184a (i) separates the second front gasket surface 180a from the second rear gasket surface 182a, and (ii) has at least one second set screw aperture 186a that extends from the second side gasket surface 182a to the second gasket aperture 178a.

The at least one second gasket fastener 715a which can be a screw, a bolt or equivalent thereof, passes through at least one second fastener aperture 720a positioned around the distal aperture 312 on the distal downward area 128, and a corresponding second gasket-fastener aperture 722a. Preferably the corresponding second gasket-fastener aperture 722a is threaded to secure the second bushing gasket 176a, and optionally, the second gasket washer 717a, to the distal downward area 128.

The second bushing nut 190a securely attaches to the second bushing threaded area 273a that projects beyond the second front gasket surface 180a as illustrated at FIG. 3.

The second bolt 174a has a second head 230a, a second threaded end 232a, and a second length greater than the second head threaded bushing 172a as illustrated at FIG. 3. The second threaded end 232a is adapted to be inserted into the second central aperture 275a in order to threadably connect with the distal (or second) threaded aperture 412 when the support accessory 100 is positioned and adapted to be detachably fastened to the power hand tool 400.

The at least one second set screw 180a is adapted to (a) being screwed in the at least one second set screw aperture 186a, (b) contact the second bushing threaded area 273a, and (c) secure the position of the second securing apparatus 170a in a desired location in the distal aperture 312.

As discussed above, when the power hand tool 400 is capable of pivoting about the aperture axis 414 when the first securing apparatus 170 and the second securing apparatus 170a are not locked into position. Once first securing apparatus 170 and the second securing apparatus 170a are locked into position the power hand tool 400 is not capable of pivoting about the aperture axis 414. That means, the support housing 100 is adapted to (a) remain stationary and (b) be secured to the power hand tool 400.

The support accessory 100, optionally, has a coolant manifold 800 as illustrated at FIG. 1. The coolant manifold 800 has (a) a mixing chamber 802 that mixes (i) gas received from an air hose (not shown) adapted to be connected to a gas inlet 804, and (ii) a fluid received from a coolant hose 806 adapted to be connected to a fluid supply (not shown), and (b) a flexible hose 808 having a spray nozzle 810 that directs the fluid toward the tool. Also, the coolant hose 806 has a filter 812. The coolant manifold 800 is attached to the support housing 100 through a plurality of fasteners, like screws or bolts 820. In many instances, the proximal downward area 126 has at least one coolant manifold aperture 822 (see, FIG. 4); and the distal downward area 128 has a corresponding at least one coolant manifold aperture 822a (see, FIG. 5) that can receive the manifold screws or bolts 820 to secure the coolant manifold 800 to either or both sides of the support housing 100.

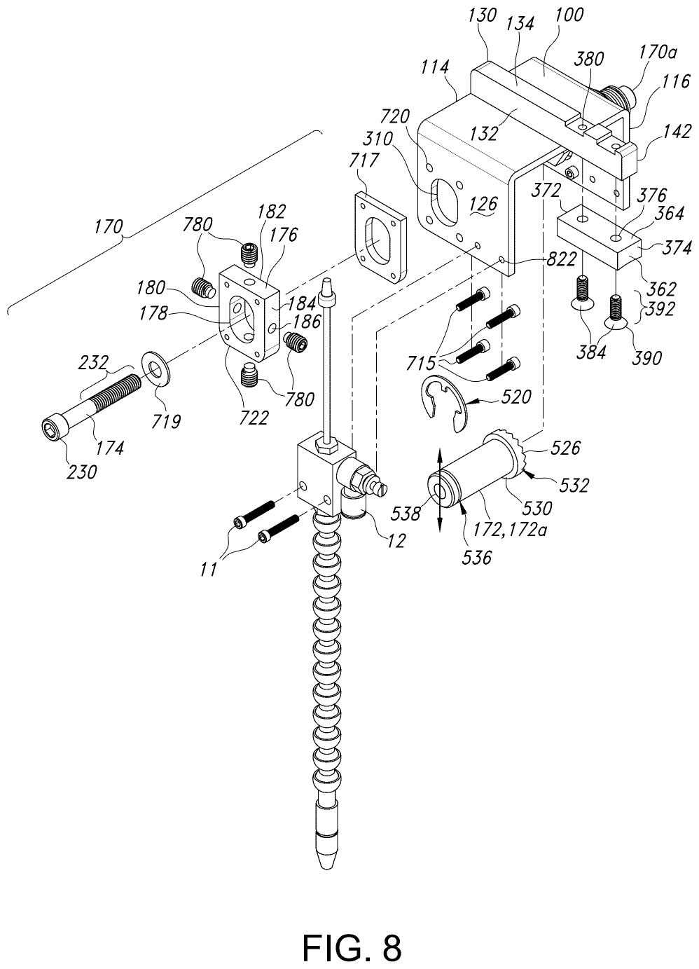

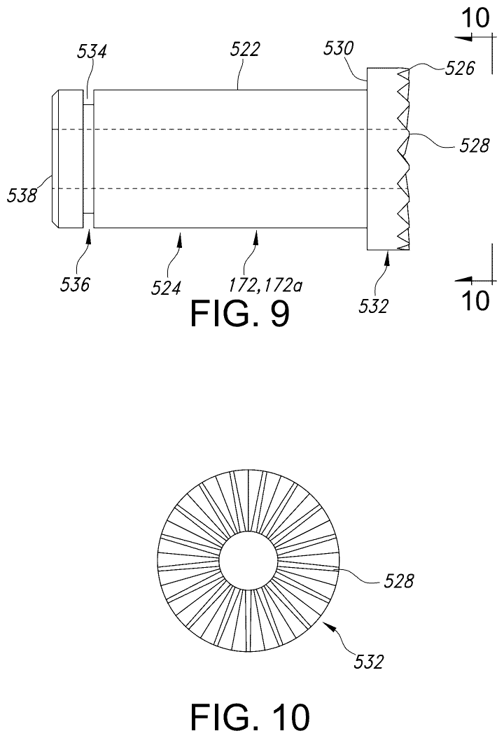

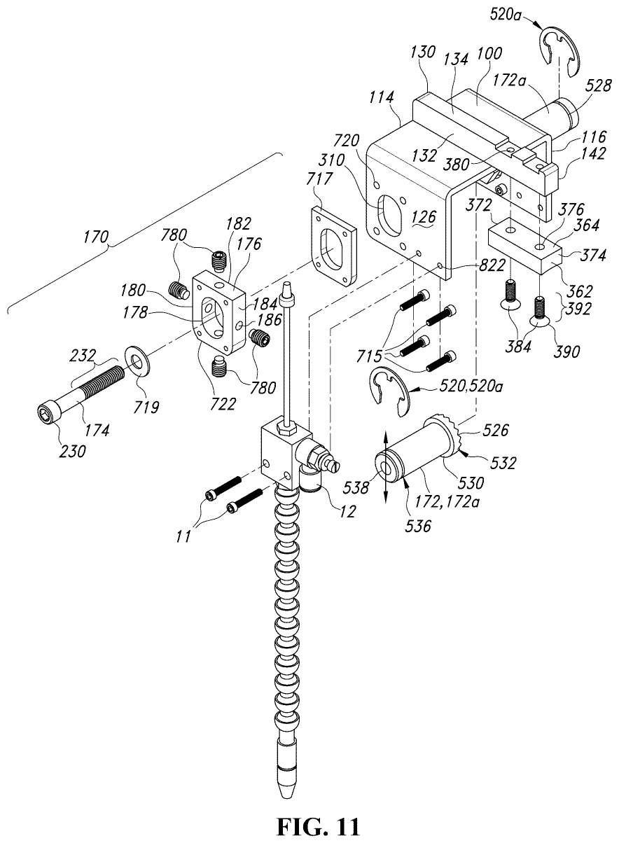

Alternatively, as shown in FIGS. 8, 9 and 10, the first bushing nut 190 can be replaced by a snap ring 520 and the first head threaded rod with a manufactured nut 172 can be replaced by a threaded or non-threaded tube 522. The threaded or non-threaded tube 522 has an exterior surface, wherein the exterior surface can have a circular or cylindrical shape as shown in FIGS. 9 and 10, a square shape, or a polygonic shape. Whatever the exterior shape of the tube 522 is, the tube 522 has:
(i) a first diameter or perimeter 524 capable of being (a) inserted into the proximal aperture 310 and the first gasket aperture 178 and (b) secured in place by first set screws 780 to accommodate different power tools and different sized power tools,
(ii) a compression knob 526 having (a) a ribbed and trough (when used on a cylindrical tube or shaft, it is sometimes referred to as a Hirth joint that consists of radial teeth formed by grooves milled or ground into the end face of the cylindrical shaft and wherein the teeth mesh around a ring, as the torque capacity of teeth increases with their diameter) configuration proximal surface 528 capable of contacting the power tool surface, (b) a distal surface 530 capable of contacting the interior surface of the distal downward area 128, and a second diameter or perimeter 532 wherein the second diameter perimeter is greater than the first diameter or perimeter 524;
(iii) a groove 534(a) having a third diameter or perimeter 536, wherein the third diameter or perimeter 536 is less than the first diameter perimeter 524 and greater than the tube's inner diameter (shown by dotted lines), (b) positioned near and not at the terminal distal end of the tube 522 and (c) capable of receiving the snap ring 520.

With this alternative structure, the threaded or non-threaded tube 522 is capable of being moved (a) back & forth within the proximal aperture 310 and the first gasket aperture 178 and/or (b) up & down within the proximal aperture 310 and the first gasket aperture 178. By moving back & forth and/or up & down, the compression knob 526 is capable of (a) contacting the power hand tool secured by this invention and (b) being secured in place by first set screws 780 once it is properly positioned onto the power hand tool. Simultaneously, the first bolt 174 is capable of being (a) positioned into the tube's aperture 538 and (b) securely attached to the power hand tool being secured by this invention. This alternative embodiment permits different power hand tool devices and sizes to be attached to the mounting device since the snap ring permits the movement of the bushing nut for different power hand tool devices and different sized power hand tool devices. When this alternative version is used, the locking band clamp 146 need not be used; and the clamp-locking protrusion or longitudinal beam 130, the saddle 362, and corresponding components need not be used when the snap ring and tube configuration embodiment are used on both sides of the U-shaped support housing.

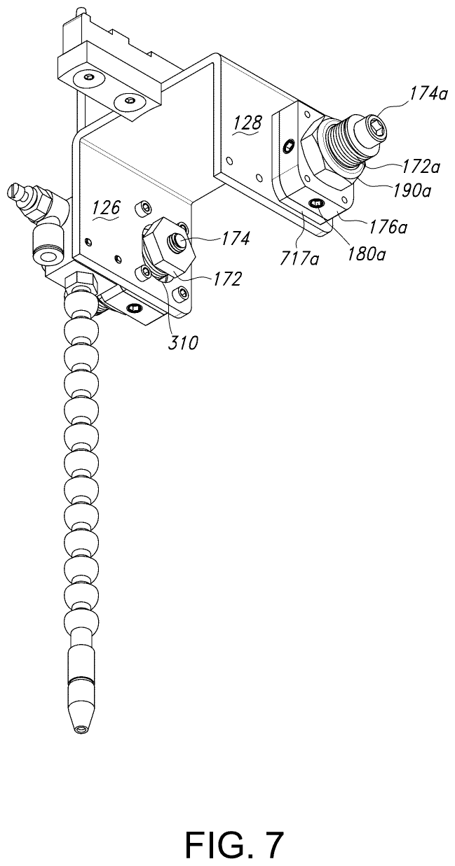

Obviously, the snap ring and tube configuration embodiment can be used on both sides of the U-shaped support housing or one side of the U-shaped support. That said, FIG. 8 illustrates the connection system shown in FIGS. 1 to 7 is being used on the farther side of the U-shaped support housing as shown in FIG. 8; with the snap ring and tube configuration embodiment on the closer side of the U-shaped support housing as shown in FIG. 8 and in an exploded format.

While the invention has been described using some specific examples, many modifications and variations are possible. It is therefore understood that the invention is not limited in any way, other than by the scope of the appended claims.

It is expected that during the life of this patent many variations thereon will be developed and the scope of the invention includes all such new technologies a priori.

As used herein the term “about” refers to ±10% of the recited value.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method or a process can be used to characterize an apparatus and features used to describe an apparatus can be used to characterize a method or a process.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module, or process is an explicit statement that additional embodiments of the invention not including the recited feature, part, component, module, or process exist.

Alternatively or additionally, various exemplary embodiments of the invention exclude any specific feature, part, component, module, process, or element which is not specifically disclosed herein.

All publications, references, patents, and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A support accessory configured to be detachably fastened to a power hand tool, the power hand tool has a tool and a motor housing, the motor housing has (a) a motor, interconnected to a power source, wherein the power source and the motor power and move the tool, and (b) a first threaded aperture and a second threaded aperture, wherein each of the first and second threaded aperture is adapted to receive an idle handle or a side handle;
the support accessory comprising:
(A) a U-shaped support housing having
an exterior surface, an interior surface, and a side surface that separates the exterior surface from the interior surface;
a proximal end, a distal end, a front end, a rear end, and a middle area, the middle area (a) is at or near the mid-point between the proximal end and the distal end, and (b) extends from the front end to the rear end;
a proximal bend area that (i) is between the middle area and the proximal end, and (ii) extends from the front end to the rear end;
a distal bend area that (i) is between the middle area and the distal end and (ii) extends from the front end to the rear end;
a spacing area positioned between the proximal bend area and the distal bend area and includes the middle area,
a proximal downward area (i) between the proximal end and the proximal bend area and (ii) has a proximal aperture,
a distal downward area (i) between the distal end and the distal bend area and (ii) has a distal aperture;
wherein the distal aperture is positioned to align with the first threaded aperture and the proximal aperture is positioned to align with the second threaded aperture when the support accessory is detachably fastened to the power hand tool;
(B) a clamp-locking protrusion has
a clamp-locking proximal surface, a clamp-locking top surface, a clamp-locking distal surface, a clamp-locking bottom surface, a clamp-locking front surface, and a clamp-locking rear surface,
a clamp section and a locking section wherein (a) clamp-locking bottom surface of the clamp section securely attaches to the exterior surface's middle area 114 and (b) clamp-locking bottom surface of the locking section extends beyond the housing rear end, and
at least one locking indentation on the clamp-locking top surface of the locking section so a locking band clamp can be adapted to be positioned in the at least one locking indentation and around the motor housing when the support accessory is detachably fastened to the power hand tool;
(C) a first securing apparatus and a second securing apparatus, wherein the first securing apparatus has
(a) a first head threaded bushing, the first head threaded bushing has (i) a first bushing distal end, (ii) a first bushing proximal end, (iii) a first bushing threaded area positioned between the first bushing distal end and the first bushing proximal end, and (iv) a first central aperture that extends from the first bushing distal end to the first bushing proximal end,
the first bushing proximal end has a first head portion having (a) a first head distal end adapted to contact at least some of the interior surface surrounding the distal aperture when the first bushing distal end and the first bushing threaded area are inserted into and through the distal aperture, and (b) a first head proximal end adapted to face the motor housing when the support accessory is detachably fastened to the power hand tool,
(b) a first bushing gasket, the first bushing gasket has
a first gasket aperture that corresponds in shape and size of the distal aperture;
a first front gasket surface, a first rear gasket surface, and a first side gasket surface,
the first rear gasket surface faces the exterior surface of the distal downward area;
the first bushing gasket is securely positioned over the exterior surface of distal downward area so the first gasket aperture and the distal aperture are aligned, and
the first side gasket surface
(i) separates the front gasket surface from the rear gasket surface, and
(ii) has at least one first set screw aperture that extends from the first side gasket surface to the first gasket aperture;
(c) a first bushing nut, the first bushing nut securely attaches to the first bushing threaded area that projects beyond the first front gasket surface,
(d) a first bolt, the first bolt has a first head, a first threaded end, and a first length greater than the length of the first head threaded bushing, the first threaded end is adapted to be inserted into the first central aperture in order to threadably connect with the first threaded aperture when the support accessory is positioned and adapted to be detachably fastened to the power hand tool; and
(e) at least one first set screw, the at least one first set screw is adapted to (a) being screwed in the at least one first set screw aperture, (b) contact the first bushing threaded area, and (c) secure the position of the first securing apparatus in place;
wherein the second securing apparatus has
(a.2) a second head threaded bushing, the second head threaded bushing has (i) a second bushing distal end, (ii) a second bushing proximal end, (iii) a second bushing threaded area positioned between the second bushing distal end and the second bushing proximal end, and (iv) a second central aperture that extends from the second bushing distal end to the second bushing proximal end,
the second bushing proximal end has a second head portion having (a) a second head distal end adapted to contact at least some of the interior surface surrounding the proximal aperture when the second bushing distal end and the second bushing threaded area are inserted into and through the proximal aperture, and (b) a second head proximal end adapted to face the motor housing when the support accessory is detachably fastened to the power hand tool,
(b.2) a second bushing gasket, the second bushing gasket has
a second gasket aperture that corresponds in shape and size of the proximal aperture;
a second front gasket surface, a second rear gasket surface, and a second side gasket surface,
the second rear gasket surface faces the exterior surface of proximal downward area;
the second bushing gasket is securely positioned over the exterior surface of proximal downward area so the second gasket aperture and the proximal aperture are aligned, and
the second side gasket surface
(i) separates the second front gasket surface from the second rear gasket surface, and
(ii) has at least one second set screw aperture that extends from the second side gasket surface to the second gasket aperture;
(c.2) a second bushing nut, the second bushing nut securely attaches to the second bushing threaded area that projects beyond the second front gasket surface,
(d.2) a second bolt, the second bolt has a second head, a second threaded end, and a second length greater than length of the second head threaded bushing, the second threaded end is adapted to be inserted into the second central aperture in order to threadably connect with the second threaded aperture when the support accessory is detachably fastened to the power hand tool; and
(e.2) at least one second set screw, the at least one second set screw is adapted to (a) being screwed in the at least one second set screw aperture, (b) contact the second bushing threaded area, and (c) secure the position of the second securing apparatus in place.

2. The support apparatus of claim 1 further comprising a saddle, the saddle has a saddle top surface, a saddle bottom surface, and at least one saddle aperture that extends from the saddle bottom surface to the saddle top surface, the saddle top surface contacts the locking section's bottom surface, and the saddle attaches to the locking section's bottom surface.

3. The support apparatus of claim 2 further comprising at least one threaded locking aperture on the locking section and extending from the clamp-locking top surface to the clamp-locking bottom surface.

4. The support apparatus of claim 2 further comprising at least one threaded locking aperture on the locking section and extending from the clamp-locking bottom surface toward the clamp-locking top surface.

5. The support apparatus of claim 2 wherein the saddle bottom surface is adapted to contact the motor housing.

6. The support apparatus of claim 5 wherein the saddle bottom surface is a concave surface.

7. The support apparatus of claim 4 wherein the at least one saddle aperture and the at least one threaded locking aperture are aligned.

8. The support apparatus of claim 7 further comprising at least one saddle bolt, the at least one saddle bolt has a head and a threaded distal end, the head is adapted to contact the saddle bottom surface and the threaded distal end extends through the at least one saddle aperture and secures to the at least one threaded locking aperture.

9. The support apparatus of claim 1 further comprising a gasket adapted to contact an exterior bushing surface of the head threaded bushing between the head distal end and the bushing distal end.

10. The support apparatus of claim 9 wherein the gasket has at least one locking screw adapted to contact the exterior bushing surface.

11. The support apparatus of claim 9 further comprising a locking nut adapted to contact the exterior bushing surface between the gasket and the bushing distal end.

12. The support apparatus of claim 9 wherein the gasket is adapted to be secured to the support housing's exterior surface.

13. The support apparatus of claim 12 further comprising at least one gasket bolt having a head end and a thread end, wherein the head end contacts the interior surface, and the thread end protrudes through the housing and into the gasket.

14. The support apparatus of claim 9 further comprising a gasket washer positioned between the gasket and the exterior surface.

15. The support accessory of claim 1 wherein the proximal downward area has a first distance between the proximal bend area and the proximal end, and the distal downward area has the first distance between the distal bend area and the distal end.

16. The support accessory of claim 1, wherein the hand tool is selected from the group consisting of an oscillating tool, a grinder, a polisher, a sander, a metal cutter, a circular saw, a jigsaw, a drill, a hammer-drill, and a router.

17. The support accessory of claim 1, wherein the support housing is adapted to (a) remain stationary and (b) be secured to the hand tool.

18. The support accessory of claim 1 further comprising a coolant manifold, the coolant manifold has (a) a mixing chamber that mixes (i) gas received from an air hose adapted to be connected to a gas supply, (ii) a fluid received from a coolant hose adapted to be connected to a fluid supply, and (b) a flexible hose having a spray nozzle that directs the fluid toward the tool.

19. The support accessory of claim 1 wherein the proximal aperture and the distal aperture are circular or oblong in shape.

20. A support accessory configured to be detachably fastened to a power hand tool, the power hand tool has a tool and a motor housing, the motor housing has (a) a motor, interconnected to a power source, wherein the power source and the motor power and move the tool, and (b) a first threaded aperture and a second threaded aperture, wherein each of the first and second threaded aperture is adapted to receive an idle handle or a side handle;
the support accessory comprising:
(A) a U-shaped support housing having
an exterior surface, an interior surface, and a side surface that separates the exterior surface from the interior surface;
a proximal end, a distal end, a front end, a rear end, and a middle area, the middle area (a) is at or near the mid-point between the proximal end and the distal end, and
(b) extends from the front end to the rear end;
a proximal bend area that (i) is between the middle area and the proximal end, and (ii) extends from the front end to the rear end;
a distal bend area that (i) is between the middle area and the distal end and (ii) extends from the front end to the rear end;
a spacing area positioned between the proximal bend area and the distal bend area and includes the middle area,
a proximal downward area (i) between the proximal end and the proximal bend area and (ii) has a proximal aperture,
a distal downward area (i) between the distal end and the distal bend area and (ii) has a distal aperture;
wherein the distal aperture is oblong in shape to be capable of being positioned to align with the first threaded aperture and the proximal aperture is oblong in shape to be capable of being positioned to align with the second threaded aperture when the support accessory is detachably fastened to the power hand tool;
(B) at least a first securing apparatus wherein the first securing apparatus has
(a) a first bushing gasket, the first bushing gasket has
a first gasket aperture that corresponds in shape and size of the distal aperture;
a first front gasket surface, a first rear gasket surface, and a first side gasket surface,
the first rear gasket surface faces the exterior surface of the distal downward area;
the first bushing gasket is securely positioned over the exterior surface of distal downward area, so the first gasket aperture and the distal aperture are aligned, and
the first side gasket surface
(i) separates the front gasket surface from the rear gasket surface, and
(ii) has at least one first set screw aperture that extends from the first side gasket surface to the first gasket aperture;
(iii) at least one first set screw, the at least one first set screw is adapted to being screwed in the at least one first set screw aperture,
(b) a threaded or non-threaded tube and a snap ring, the threaded or non-threaded tube has:
(i) an exterior surface selected from the group consisting of a circular shape, a square shape, and a polygonic shape;
(ii) a first diameter or perimeter capable of being (a) inserted into the distal aperture and the first gasket aperture and (b) secured in place by the at least one first set screw to accommodate different power tools and different sized power tools,
(iii) a compression knob having (a) a ribbed and trough configuration proximal surface capable of contacting the motor housing, (b) a distal surface capable of contacting the interior surface of the distal downward area, and (c) a second diameter or perimeter wherein the second diameter or perimeter is greater than the first diameter or perimeter;
(iv) a groove (a) having a third diameter or perimeter, wherein the third diameter or perimeter is less than the first diameter perimeter and greater than the tube's inner diameter, (b) positioned near and not at the terminal distal end of the tube and (c) capable of receiving the snap ring.

21. The support accessory of claim 20; further comprising:
(C) at least a second securing apparatus wherein the second securing apparatus has
(a) a second bushing gasket, the second bushing gasket has
a second gasket aperture that corresponds in shape and size of the proximal aperture;
a second front gasket surface, a second rear gasket surface, and a second side gasket surface,
the second rear gasket surface faces the exterior surface of the proximal downward area;
the second bushing gasket is securely positioned over the exterior surface of proximal downward area, so the second gasket aperture and the proximal aperture are aligned, and
the second side gasket surface
(i) separates the front gasket surface from the rear gasket surface, and
(ii) has at least one second set screw aperture that extends from the second side gasket surface to the second gasket aperture;
(iii) at least one second set screw,
the at least one second set screw is adapted to being screwed in the at least one second set screw aperture,
(b) a second threaded or non-threaded tube and a second snap ring, the second threaded or non-threaded tube has:
(i) an exterior surface selected from the group consisting of a circular shape, a square shape, and a polygonic shape;
(ii) a second-first diameter or perimeter capable of being (a) inserted into the proximal aperture and the first gasket aperture and (b) secured in place by the at least one first set screw to accommodate different power tools and different sized power tools,
(iii) a second compression knob having (a) a ribbed and trough configuration proximal surface capable of contacting the motor housing, (b) a distal surface capable of contacting the interior surface of the proximal downward area, and (c) a second-second diameter or perimeter wherein the second-second diameter or perimeter is greater than the second-first diameter or perimeter;
(iv) a second groove (a) having a second-third diameter or perimeter, wherein the second-third diameter or perimeter is less than the second-first diameter perimeter and greater than the second tube's inner diameter, (b) positioned near and not at the terminal distal end of the tube and (c) capable of receiving the second snap ring.
